(19) United States
(12) Patent Application Publication
(10) Pub. No.: US 2025/0048466 A1
(43) Pub. Date: Feb. 6, 2025

(54) CONTROL MODULE FOR CONVERTING SINGLE BLUETOOTH SIGNAL TO MULTIPLE SIGNALS AND APPLICATION THEREOF

(71) Applicant: HUIZHOU VOLANT ROC ELECTRONICS TECH CO., LTD., Huizhou (CN)

(72) Inventor: Jianbo Liu, Huizhou (CN)

(21) Appl. No.: 18/922,508

(22) Filed: Oct. 22, 2024

Related U.S. Application Data
(63) Continuation of application No. PCT/CN2022/132395, filed on Nov. 16, 2022.

(30) Foreign Application Priority Data
Apr. 29, 2022 (CN) 202210463657.6

(51) Int. Cl. H04W 76/15; H04W 72/40

(52) U.S. Cl. CPC H04W 76/15; H04W 72/40

(57) ABSTRACT

The present disclosure relates to the technical field of signal separation transmission and, particularly, to a control module for converting single bluetooth signal to multiple signals and an application thereof. The control module for converting single bluetooth signal to multiple signals includes a receiving chip and a transmitting chip in communicative connection with each other. The receiving chip is in communicative connection with an audio input device and is electrically connected to a display module, the transmitting chip is in communicative connection with an audio output device; the receiving chip is configured to receive audio data of the audio input device and transmit the audio data to the transmitting chip, and configured to output drive signals of varying amplitudes to the display module according to audio data energy value; the transmitting chip is configured to play the audio data through the audio output device.

### CROSS-REFERENCE TO RELATED APPLICATIONS

The present disclosure is a Continuation Application of PCT Application No. PCT/CN2022/132395 filed on Nov. 16, 2022, which claims the priority of Chinese Patent Application No. 2022104636576 filed on Apr. 29, 2022 before CNIPA. All the above are hereby incorporated by reference in their entirety.

### TECHNICAL FIELD

The present disclosure relates to the technical field of signal separation transmission and, particularly, to a control module for converting single bluetooth signal to multiple signals and an application thereof.

### BACKGROUND

The vehicle interior ambient lighting is a lighting that serves a decorative purpose. Multiple light strips are usually provided in places such as the center console, door panels, roof and center passageway. They are available in single or multiple colors to create a variety of pleasant atmospheres. In practical applications, the vehicle ambient lighting also changes the lights in rhythm with the music, achieving flashing changes.

Presently, there are two main technologies on the market for lighting control that pick up the rhythm of music. 1) Microphones pick up external sounds and convert the signals to control the flashing effect of the lights. However, there may be other noise interference due to the complexity of external sound sources, which causes confusion between the rhythm of the music and the lighting effect, and does not achieve a relatively high degree of fit, resulting in a poor user experience. 2) signals are transmitted to the lights via BLE technology to achieve the effect of flashing with the audio. However, BLE technology music can only be downloaded to the local app, so that the music data can be transmitted via BLE and control the flashing of the lights. Yet most people prefer to listen to music on third-party music apps, rendering this solution also incompatible with user needs.

Therefore, a control module for converting single bluetooth signal to multiple signals and an application thereof have emerged.

### SUMMARY

Provided in the present disclosure is a control module and an application for converting a single bluetooth signal to multiple signals, mainly addressing the problem of relatively high noise interference in the existing technical solution of controlling the ambient light flashing with the rhythm of the music due to picking up ambient sound, and the problem of the light flashing not matching the music rhythm, as well as the problem of playing online audio and transmitting it via BLE technology, which does not conform to users' music playing habits, resulting in poor user satisfaction.

Proposed in the present disclosure is a control module for converting single bluetooth signal to multiple signals, including a receiving chip and a transmitting chip in communicative connection with each other. The receiving chip is in communicative connection with an audio input device and is electrically connected to a display module, and the transmitting chip is in communicative connection with an audio output device.

The receiving chip is configured to receive audio data of the audio input device and transmit the audio data to the transmitting chip, and configured to output drive signals of varying amplitudes to the display module according to audio data energy value.

The transmitting chip is configured to play the audio data through the audio output device.

In some implementations, the receiving chip is configured to receive audio data of the audio and transmit the audio data to the transmitting chip, and configured to output drive signals of varying amplitudes to the display module according to audio data energy value.

In some implementations, an indicator light is provided on the receiving chip and the transmitting chip respectively, and

the indicator light is configured to identify different pairing states of the receiving chip and the transmitting chip.

In some implementations, a ready-to-pair state and a successful connected state of both the receiving chip and the transmitting chip correspond to different lighting states of the indicator lights, and the indicator lights in different connecting states of the receiving chip and the transmitting chip are same in color.

In some implementations, the audio input device is a mobile terminal; the display module is an ambient light; and

The control module for converting single bluetooth signal to multiple signals is connected to the mobile terminal and the audio output device through Bluetooth communication.

In some implementations, the transmitting chip is further configured to search for pairable devices within a signal range, configured to actively initiate pairing requests to the pairable devices, and configured to send information about paired devices to the mobile terminal.

In some implementations, the control module for converting single bluetooth signal to multiple signals further includes a display screen.

The display screen is configured to display all the mobile terminals or audio output devices that are currently connectable, configured to select any of the mobile terminals or audio output devices by touch control, and configured to view information about the mobile terminals or audio output devices that complete the connection.

Proposed in the present disclosure is further a vehicle signal separation control system, including the control module for converting single bluetooth signal to multiple signals mentioned above and a vehicle entertainment system, and the control module is in communicative connection with a mobile terminal, the vehicle entertainment system, and a vehicle ambient light respectively.

The control module for converting single bluetooth signal to multiple signals is configured to receive audio data of the mobile terminal, configured to transmit the audio data to the vehicle entertainment system, and configured to output drive signals of varying amplitudes to the vehicle ambient light according to the audio data energy value.

The vehicle entertainment system is configured to receive and play the audio data.

Proposed in the present disclosure is a vehicle control system, the vehicle control system includes the aforementioned vehicle signal separation control system.

In some implementations, the vehicle control system includes a power supply module electrically connected to the vehicle signal separation control system, and the power supply module is further provided with a USB connector.

It can be seen from the above that the following beneficial effects can be obtained by applying the technical solutions provided by the present disclosure:

The system proposed by the present disclosure is provided with a control module for converting single bluetooth signal to multiple signals. After the bluetooth device is connected to the control module, two groups of bluetooth audio signals and light control signals are transmitted. The probability of transmission interference is extremely low since they are internal signals. At the same time, it does not affect the playing of music on the third-party application platform, which conforms to the users' music playing habits. At the same time, it also ensures that the ambient light flashes and the music rhythm changes are highly consistent.

### BRIEF DESCRIPTION OF THE DRAWINGS

In order to illustrate the technical solutions of the embodiments of the present disclosure or of the prior art more clearly, the following drawings are briefly described as required in the context of the embodiments or the prior art. Obviously, the following drawings illustrate only some of the embodiments of the present disclosure. Other relevant drawings may be obtained on the basis of the provided drawings without any creative effort by those skilled in the art.

FIG. 1 is a schematic structural diagram of a control module for converting single bluetooth signal to multiple signals in embodiments of the present disclosure;

FIG. 2 is a schematic circuit diagram of a control module for converting single bluetooth signal to multiple signals in embodiments of the present disclosure;

FIG. 3 is a schematic structural diagram of a vehicle signal separation control system in embodiments of the present disclosure; and

FIG. 4 is a schematic structural diagram of a vehicle control system in embodiments of the present disclosure.

Labels: control module 100, receiving chip 101, transmitting chip 102, audio input device 103, display module 104, audio output device 105, vehicle signal separation control system 200, vehicle entertainment system 201, vehicle ambient light 202, mobile terminal 203, vehicle control system 300, power supply module 301, and USB connector 302.

### DETAILED DESCRIPTION

The technical solutions in the embodiments of the present disclosure are clearly and completely described and discussed below in conjunction with the attached drawings of the embodiments of the present disclosure. Obviously. the embodiments described herein are only some of the embodiments of the present disclosure but not all of them. Based on the embodiments in the present disclosure, all other embodiments obtained by those skilled in the art without creative efforts fall within the scope of protection of the present disclosure.

In the existing technical solution of controlling the ambient light flashing with the rhythm of the music, there is relatively high noise interference due to picking up ambient sound, resulting in the problem of the light flashing not matching the music rhythm, and the problem of playing online audio and transmitting it via BLE technology, which does not conform to users' music playing habits, resulting in poor user satisfaction.

### Embodiment I

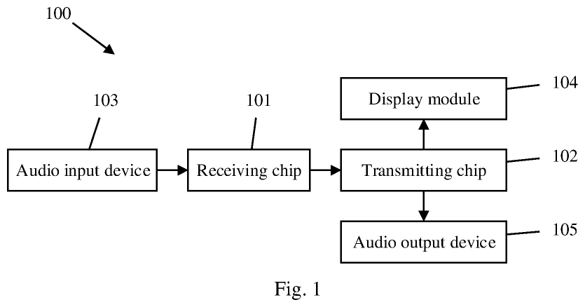

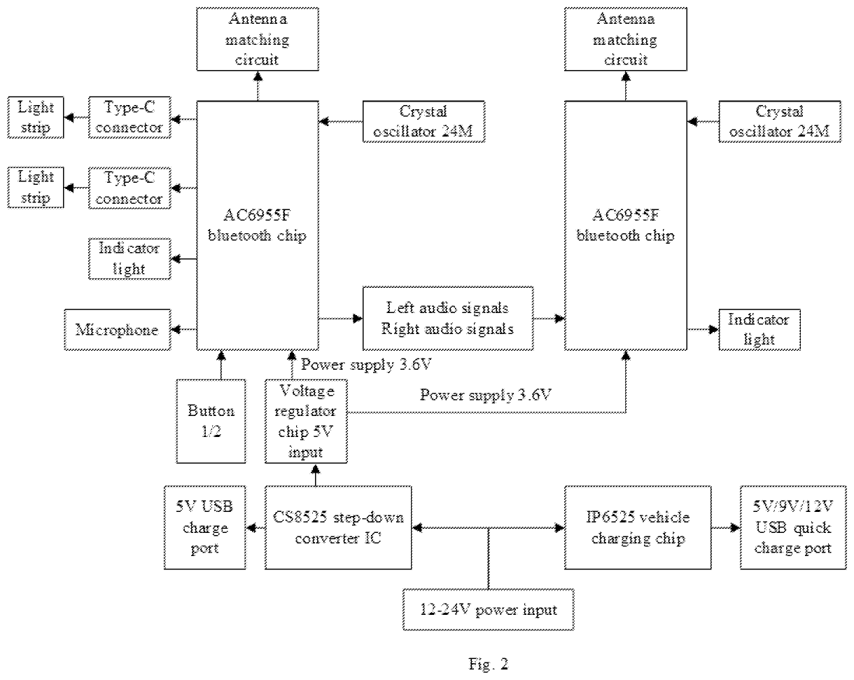

Referring to FIGS. 1 and 2, in order to solve the aforementioned problems, proposed in the present embodiment is a control module 100 for converting a single bluetooth signal to multiple signals, mainly including a receiving chip 101 and a transmitting chip 102 in communicative connection with each other. The receiving chip 101 is in communicative connection with an audio input device 103 and is electrically connected to a display module 104, and the transmitting chip 102 is in communicative connection with an audio output device 105.

The receiving chip 101 is configured to receive audio data of the audio input device 103 and transmit the audio data to the transmitting chip 102, and configured to output drive signals of varying amplitudes to the display module 104 according to audio data energy value; the transmitting chip 102 is configured to play the audio data through the audio output device 105.

In some implementations, the receiving chip 101 and the transmitting chip 102 are connected to the audio input device 103 and the audio output device 105 through near-field communication such as bluetooth; and the receiving chip 101 is mainly connected to the display module 104 through a connection line. In some implementations, a communication interface is provided on the receiving chip 101, and the communication interface is connected with a connection line of the display module 104.

In some implementations, one or more communication interfaces are provided on the receiving chip 101, that is, one or more display modules 104 are connected on the receiving chip 101. In some implementations, different display modules 104 may display the same content if multiple display modules 104 are present in the present disclosure.

More specifically, the receiving chip 101 is configured to control the display module 104 according to the audio data. Specifically, the receiving chip 101 is configured to output drive signals of varying amplitudes to the display module 104 according to audio data energy value;

In some implementations, the energy value of the audio data in the present embodiment should be the data acquired regularly, for example, the energy value of the audio data acquired every 50 ms.

In some implementations, the energy value in the present embodiment includes the pitch of the audio data, the rapidity of the rhythm changes, and the like. In some implementations, if there is a high pitch or a low pitch in the audio data, different contents are displayed on the display module 104 accordingly; or the contents of the display module 104 are different when the rhythm changes quickly or slowly.

In some implementations, the display module 104 in the present embodiment receives drive signals of different amplitudes, which may be implemented singly by means of amplitude change, conduction, power off, or the like, or in combination.

In some implementations, when a display screen is adopted as the display module 104, the display content on the display screen can be shown as a columnar chart. For example, when there is a high pitch, the columnar height may be relatively high, and the low pitch applies to the same; when the rhythm changes rapidly, the columnar chart may adopt a fast switching method. An LED light may also be adopted as the display module 104, the energy value of the audio data may be displayed through different brightness, different colors, and flashing changes; the remaining display modules 104 can be replaced equally.

More specifically, the receiving chip 101 and the transmitting chip 102 are respectively provided with indicator lights; the indicator lights are configured to identify different pairing states of the receiving chip 101 and the transmitting chip 102.

In some implementations, a ready-to-pair state and a successful connected state of both the receiving chip 101 and the transmitting chip 102 correspond to different lighting states of the indicator lights, and the indicator lights in different connecting states of the receiving chip 101 and the transmitting chip 102 are same in color.

In some implementations, the indicator light of the receiving chip 101 in the present embodiment indicates the current state in a blue light slow-flashing manner while waiting for pairing, and indicates the current state in a blue light steady-light manner after successful connection; the indicator light of the transmitting chip 102 indicates the current state in a red light slow-flashing manner while waiting for pairing, and indicates the current state in a red light steady-light manner after successful connection.

More specifically, in some embodiment, the audio input device 103 is a mobile terminal; the display module 104 is an ambient light; and the signal separation device is respectively connected with the mobile terminal and the audio output device 105 through bluetooth communication. In some implementations, the connection states between the mobile terminal and the receiving chip 101 can be viewed on the mobile terminal.

In some implementations, the transmitting chip 102 is further configured to search for pairable devices within a signal range, configured to actively initiate pairing requests to the pairable devices, and configured to send information about paired devices to the mobile terminal.

In some implementations, a display screen is further provided on the control module 100. The display screen is configured to display all the mobile terminals or audio output devices 105 that are currently connectable, configured to select any of the mobile terminals or audio output devices 105 by touch control, and configured to view information about the mobile terminals or audio output devices 105 that are currently connected.

In some implementations, a bidirectional transmission device can be selected directly on the display screen of the control module 100, and a unidirectional transmission device can also be selected. For example, when a bidirectional transmission device is selected, a plurality of devices that can be currently connected are listed on the display screen, including mobile terminals and audio output devices 105, and after being connected, a signal defining a receiving mobile terminal can be set to be received and forwarded to a specific audio output device 105. If a unidirectional transmission device is selected, the mobile terminal can be used to select the control module 100 as a receiving object, and any audio output device 105 can be selected as a receiving object on the control module 100.

In some implementations, when the mobile terminal and the control module 100 are connected to the audio output device 105 and the ambient light, the audio data selected by the mobile terminal is carried out a separation of the audio signal and the amplitude signal through the control module 100, and the amplitude signal is transmitted to the ambient light, which is manifested as such as a flicker change and a color temperature change, while the audio signal is transmitted to the audio output device 105 for audio playing, which realizes the fitting of the audio data and the light change, improves the ambient rendering of the playing environment, and effectively ensures the synchronous transmission of the audio data and the amplitude data.

### Embodiment II

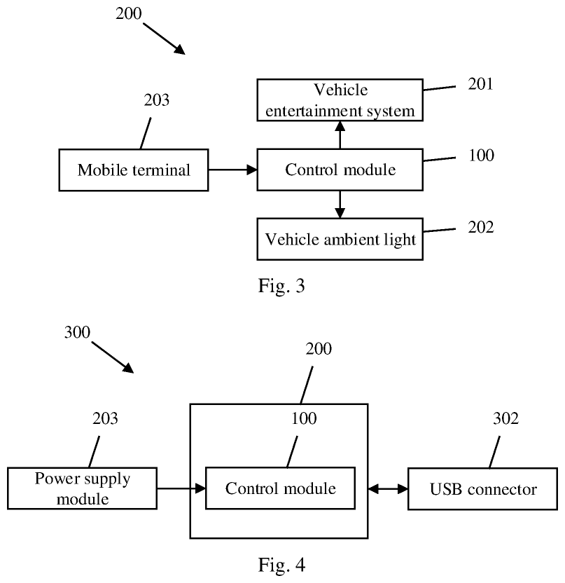

As shown in FIG. 3, in order to solve the aforementioned problems, proposed in the present disclosure is a vehicle signal separation control system, mainly including the control module 100 for converting single bluetooth signal to multiple signals in Embodiment I and a vehicle entertainment system 201, the control module 100 is in communicative connection with a mobile terminal 203, the vehicle entertainment system 201, and a vehicle ambient light 202. The control module 100 is configured to receive audio data of the mobile terminal 203, configured to transmit the audio data to the vehicle entertainment system 201, and configured to output drive signals of varying amplitudes to the vehicle ambient light 202 according to the audio data energy value; and the vehicle entertainment system 201 is configured to receive and play the audio data.

In some implementations, the control module 100 is connected to the mobile device and the vehicle entertainment system 201 through bluetooth communication, respectively.

In some implementations, the control module 100 is fixedly arranged inside the vehicle, that is, the control module 100 is factory-equipped and installed, and its invisible structure is only searched for by bluetooth signal transmission and reception. It can also be achieved by externally installing the control module 100, which usually corresponds to an external/added ambient light.

In some implementations, after the control module 100 is powered on, the receiving chip 101 is turned on at the same time as the transmitting chip 102, and the transmitting chip 102 is paired with the vehicle entertainment system 201 by default.

In some implementations, after the mobile terminal is connected to the control module 100 through bluetooth, the audio data is transmitted to the control module 100 when the audio is played. The control module 100 receives the audio data and plays it through the vehicle entertainment system 201. At the same time, the rhythm change, amplitude level, and other data in the audio data are extracted to correspondingly control the vehicle ambient light 202, so that the vehicle ambient light 202 can change with the change of the audio rhythm.

In some implementations, the control module 100 is provided with a type-C interface, which can be used to connect the vehicle ambient light. If the control module 100 is a built-in structure, the vehicle ambient light and the control module 100 are connected by pre-embedded wires. If the control module 100 is an additional structure to be mounted, the type-C interface is used to connect the additional mounted ambient light, and the connecting wires are fixed to the side wall and the center console surface of the vehicle in a fixed manner.

### Embodiment III

As shown in FIG. 4, in order to solve the above problem, proposed in the present disclosure is a vehicle control system 300, which includes the vehicle signal separation control system 200 in Embodiment II and a power supply module 301. The power supply module 301 is electrically connected to the control module 100 for converting single bluetooth signal to multiple signals, and the power supply module is further provided with a USB connector 302.

In some implementations, a plurality of USB connectors 302 may be provided in the present embodiment for charging the mobile device, and may also be configured to be connected to portable appliances and the like.

In summary, proposed in the Embodiment I to Embodiment III is a control module 100 for converting single bluetooth signal to multiple signals and application thereof. The control module transmits Bluetooth audio data and waiting control signals separately, thereby achieving internal data transmission to control the ambient light, and ensuring that the flashing changes of the ambient light are in sync with the rhythm of the audio.

The aforementioned implementations do not constitute a limitation of the scope of protection of the technical solution. Any modifications, equivalent replacements, and improvements made within the spirit and principles of the aforementioned implementations shall be included in the scope of protection of the technical solution.

1. A control module for a converting single bluetooth signal to multiple signals, comprising a receiving chip and a transmitting chip in communicative connection with each other, wherein the receiving chip is in communicative connection with an audio input device and is electrically connected to a display module, the transmitting chip is in communicative connection with an audio output device;
the receiving chip is configured to receive audio data of the audio input device and transmit the audio data to the transmitting chip, and configured to output drive signals of varying amplitudes to the display module according to audio data energy value;
the transmitting chip is configured to play the audio data through the audio output device;
the audio input device is a mobile terminal; the display module is an ambient light; and
the control module for converting a single bluetooth signal to multiple signals is configured to allow the mobile terminal to transmit the audio signal received online to the ambient light without distortion.

2. The control module for converting a single bluetooth signal to multiple signals according to claim 1, wherein an indicator light is provided on the receiving chip and the transmitting chip respectively, and the indicator light is configured to identify different pairing states of the receiving chip and the transmitting chip.

3. The control module for converting a single bluetooth signal to multiple signals according to claim 2, wherein a ready-to-pair state and a successful connected state of both the receiving chip and the transmitting chip correspond to different lighting states of the indicator lights, and the indicator lights in different connecting states of the receiving chip are same in color.

4. The control module for converting a single bluetooth signal to multiple signals according to claim 2, wherein a ready-to-pair state and a successful connected state of both the receiving chip and the transmitting chip correspond to different lighting states of the indicator lights, and the indicator lights in different connecting states of the transmitting chip are same in color.

5. The control module for converting a single bluetooth signal to multiple signals according to claim 1, wherein the communicative connection between the transmitting chip and the audio output device is any one of wired communication, bluetooth communication, or network communication.

6. The control module for converting a single bluetooth signal to multiple signals according to claim 2, wherein the communicative connection between the transmitting chip and the audio output device is any one of wired communication, bluetooth communication, or network communication.

7. The control module for converting a single bluetooth signal to multiple signals according to claim 3, wherein the communicative connection between the transmitting chip and the audio output device is any one of wired communication, bluetooth communication, or network communication.

8. The control module for converting a single bluetooth signal to multiple signals according to claim 4, wherein the communicative connection between the transmitting chip and the audio output device is any one of wired communication, bluetooth communication, or network communication.

9. The control module for converting a single bluetooth signal to multiple signals according to claim 5, wherein the transmitting chip is further configured to search for pairable devices within a signal range, configured to actively initiate pairing requests to the pairable devices, and configured to send information about paired devices to the mobile terminal.

10. The control module for converting a single bluetooth signal to multiple signals according to claim 6, wherein the transmitting chip is further configured to search for pairable devices within a signal range, configured to actively initiate pairing requests to the pairable devices, and configured to send information about paired devices to the mobile terminal.

11. The control module for converting a single bluetooth signal to multiple signals according to claim 7, wherein the transmitting chip is further configured to search for pairable devices within a signal range, configured to actively initiate pairing requests to the pairable devices, and configured to send information about paired devices to the mobile terminal.

12. The control module for converting a single bluetooth signal to multiple signals according to claim 8, wherein the transmitting chip is further configured to search for pairable devices within a signal range, configured to actively initiate pairing requests to the pairable devices, and configured to send information about paired devices to the mobile terminal.

13. The control module for converting a single bluetooth signal to multiple signals according to claim 9, further comprising a display screen, configured to display all the mobile terminals or audio output devices that are currently connectable, configured to select any of the mobile terminals or audio output devices by touch control, and configured to view information about the mobile terminals or audio output devices that complete the connection.

14. The control module for converting a single bluetooth signal to multiple signals according to claim 10, further comprising a display screen, configured to display all the mobile terminals or audio output devices that are currently connectable, configured to select any of the mobile terminals or audio output devices by touch control, and configured to view information about the mobile terminals or audio output devices that complete the connection.

15. The control module for converting a single bluetooth signal to multiple signals according to claim 11, further comprising a display screen, configured to display all the mobile terminals or audio output devices that are currently connectable, configured to select any of the mobile terminals or audio output devices by touch control, and configured to view information about the mobile terminals or audio output devices that complete the connection.

16. The control module for converting a single bluetooth signal to multiple signals according to claim 12, further comprising a display screen, configured to display all the mobile terminals or audio output devices that are currently connectable, configured to select any of the mobile terminals or audio output devices by touch control, and configured to view information about the mobile terminals or audio output devices that complete the connection.

17. A vehicle signal separation control system, comprising a control module for converting a single bluetooth signal to multiple signals and a vehicle entertainment system, the control module is in communicative connection with a mobile terminal, the vehicle entertainment system, and a vehicle ambient light respectively;
wherein the control module for a converting single bluetooth signal to multiple signals comprises a receiving chip and a transmitting chip in communicative connection with each other, wherein the receiving chip is in communicative connection with an audio input device and is electrically connected to a display module, the transmitting chip is in communicative connection with an audio output device;
the receiving chip is configured to receive audio data of the audio input device and transmit the audio data to the transmitting chip, and configured to output drive signals of varying amplitudes to the display module according to audio data energy value;
the transmitting chip is configured to play the audio data through the audio output device;
the audio input device is a mobile terminal; the display module is an ambient light;
the control module for converting a single bluetooth signal to multiple signals is configured to allow the mobile terminal to transmit the audio signal received online to the ambient light without distortion;
the communicative connection is any one of wired communication, bluetooth communication, or network communication;
the control module for converting a single bluetooth signal to multiple signals is configured to receive audio data of the mobile terminal, configured to transmit the audio data to the vehicle entertainment system, and configured to output drive signals of varying amplitudes to the vehicle ambient light according to the audio data energy value; and
the vehicle entertainment system is configured to receive and play the audio data.

18. A vehicle control system, comprising the vehicle signal separation control system according to claim 17.

19. The vehicle control system according to claim 18, comprising a power supply module electrically connected to the vehicle signal separation control system, and the power supply module is further provided with a USB connector.
